(19) United States
(12) Patent Application Publication
(10) Pub. No.: US 2018/0023943 A1
(43) Pub. Date: Jan. 25, 2018

(54) OPTICAL APPARATUSES AND METHOD OF COLLECTING THREE DIMENSIONAL INFORMATION OF AN OBJECT

(71) Applicant: SONY CORPORATION, Tokyo (JP)

(72) Inventors: TzungHan LIN, TAIPEI (TW); YuLun LIU, TAIPEI (TW)

(21) Appl. No.: 15/215,652

(22) Filed: Jul. 21, 2016

(51) Int. Cl. G01B 11/00; G01J 3/02

(52) U.S. Cl. CPC G01B 11/00; G01J 3/0229; G01J 3/0208

(57) ABSTRACT

The present disclosure relates to an optical apparatus of collecting three dimensional information of an object, which includes an optical detector, a mask, a first optical module and a second optical module. The mask has a first aperture and a second aperture separated from the first aperture by the mask. The first optical module in the first aperture to provide a first light beam of a first wavelength range in accordance with light reflected from the object. The second optical module in the second aperture to provide a second light beam of a second wavelength range in accordance with the light reflected from the object.

### BACKGROUND

Three dimensional (3D) data collection of an object may rely on speed, accuracy, and portability for purposes such as reproduction. 3D data collection technique may be applied in fields of digital imaging, computer animation, topography, reconstructive and plastic surgery, dentistry, internal medicine, rapid prototyping, etc.

Optical apparatuses may be used to the shape, contour, position or other information of the object in digitized form. For example, an optical apparatus using triangulation may include two cameras to receive light which is reflected from an object and then determines three-dimensional spatial locations for points where the light reflects from the object.

An example of a multiband camera is disclosed in WO2012066741A1, which requires a huge amount of pixels (each pixel (or a plurality of pixels) is used to collect fluxes of light of a wavelength band) to collect enough image data. However, a relatively greater sensor in size (which provides sufficient pixels) may inevitably increase physical size of the camera or adversely affect miniaturization thereof.

### BRIEF DESCRIPTION OF THE DRAWINGS

Aspects of the present disclosure are best understood from the following detailed description when read with the accompanying figures. It is noted that, in accordance with the standard practice in the industry, various features are not drawn to scale. In fact, the dimensions of the various features may be arbitrarily increased or reduced for clarity of discussion.

FIG. 1 illustrates an optical apparatus of collecting three dimensional information of an object in accordance with some embodiments of the present disclosure.

FIG. 2 illustrates an optical apparatus of collecting three dimensional information of an object in accordance with some embodiments of the present disclosure.

FIG. 3 illustrates an optical apparatus of collecting three dimensional information of an object in accordance with some embodiments of the present disclosure.

FIG. 4 illustrates an optical apparatus of collecting three dimensional information of an object in accordance with some embodiments of the present disclosure.

FIG. 5A illustrates an image of an object in accordance with some embodiments of the present disclosure.

FIG. 5B illustrates an image of an object in accordance with some embodiments of the present disclosure.

FIG. 5C illustrates an image of an object in accordance with some embodiments of the present disclosure.

### DETAILED DESCRIPTION

The following disclosure provides many different embodiments, or examples, for implementing different features of the provided subject matter. Specific examples of components and arrangements are described below to simplify the present disclosure. These are, of course, merely examples and are not intended to be limiting. For example, the formation of a first feature over or on a second feature in the description that follows may include embodiments in which the first and second features are formed in direct contact, and may also include embodiments in which additional features may be formed between the first and second features, such that the first and second features may not be in direct contact. In addition, the present disclosure may repeat reference numerals and/or letters in the various examples. This repetition is for the purpose of simplicity and clarity and does not in itself dictate a relationship between the various embodiments and/or configurations discussed.

Further, spatially relative terms, such as “beneath,” “below,” “lower,” “above,” “upper” and the like, may be used herein for ease of description to describe one element or feature's relationship to another element(s) or feature(s) as illustrated in the figures. The spatially relative terms are intended to encompass different orientations of the device in use or operation in addition to the orientation depicted in the figures. The apparatus may be otherwise oriented (rotated 90 degrees or at other orientations) and the spatially relative descriptors used herein may likewise be interpreted accordingly.

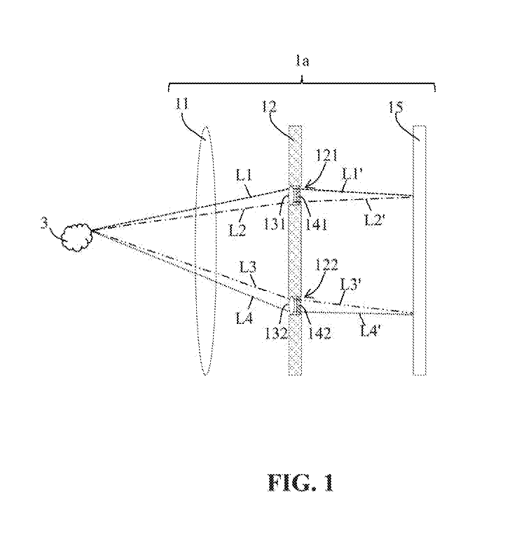

Referring to the figures, wherein like numerals indicate like parts throughout the several views. FIG. 1 illustrates an optical apparatus of collecting three dimensional information of an object in accordance with some embodiments of the present disclosure.

Referring to FIG. 1, an optical apparatus 1a of collecting three dimensional information of an object 3 may include, a mask 12, lenses 11, 131 and 132, filters 141 and 142, and an optical detector 15. The optical apparatus 1a may be, for example but is not limited to, a lens unit of a camera.

The mask 12 is opaque. The mask 12 is formed by material which absorbs incident light. The mask 12 has an aperture 121. The mask 12 has an aperture 122. The aperture 121 is separated from the aperture 122 by the mask 12. Position of the aperture 121 is different from position of the aperture 122.

Lens 11 is disposed between the object 3 the mask 12. Lens 11 is configured to shorten distance between the aperture 121 and the optical detector 15. Lens 11 is configured to shorten focal distance from the aperture 121 to the optical detector 15. Lens 11 is configured to shorten distance between the aperture 122 and the optical detector 15. Lens 11 is configured to shorten focal distance from the aperture 122 to the optical detector 15. It is contemplated that lens 11 may be eliminated in accordance with some other embodiments of the present disclosure. It is contemplated that focal distance from the aperture 122 to the optical detector 15 may increase if the lens 11 is eliminated.

An optical module (not denoted in FIG. 1) includes the lens 131 and the filter 141. The lens 131 is disposed in the aperture 121. The filter 141 is disposed in the aperture 121. The lens 131 is disposed between the filter 141 and the object 3. The optical module in the aperture 121 of the mask 12 directly provides light beams L1′ in accordance with light beam L1 reflected from the object to the optical detector 15. The optical module in the aperture 121 of the mask 12 directly provides light beams L2′ in accordance with light beam L2 reflected from the object to the optical detector 15.

The filter 141 is a band-pass filter. The filter 141 transmits light of the 430 nm to 470 nm wavelength region. The filter 141 transmits light of 470 nm to 510 nm wavelength region. The filter 141 transmits light of 510 nm to 550 nm wavelength region. The filter 141 transmits light of 550 nm to 590 nm wavelength region. The filter 141 transmits light of 590 nm to 630 nm wavelength region. The filter 141 transmits light of 630 nm to 670 nm wavelength region. The filter 141 transmits light of 670 nm to 710 nm wavelength region. The filter 141 transmits light of the 710 nm to 750 nm wavelength region wavelength region. It is contemplated that the filter 141 may transmit light of another wavelength region other than the above.

Light beam L1 is reflected by or from the object 3. Light beam L1 may pass through the lens 11 and reach the lens 131. Light beam L1 may be directed to the lens 131 by the lens 11. Light beam L1, which is incident on the lens 131, may be directed to the filter 141 by the lens 131. The filter 141, which receives the light beam L1, may provide or output a light beam L1′ of a wavelength range or spectrum, for example, from approximately 540 nanometers (nm) to approximately 560 nm. The light beam L1′ may include, for example but is not limited to green light. The optical module (not denoted in FIG. 1), which includes the lens 131 and the filter 141, provides or outputs a light beam L1′ of a wavelength range in accordance with light L1 reflected from the object 3. The light beam L1′ may be transmitted to the optical detector 15.

Light beam L2 is reflected by or from the object 3. Light beam L2 may pass through the lens 11 and reach the lens 131. Light beam L2 may be directed to the lens 131 by the lens 11. Light beam L2, which is incident on the lens 131, may be directed to the filter 141 by the lens 131. The filter 141, which receives the light beam L2, may provide or output a light beam L2′ of a wavelength range or spectrum, for example, from approximately 540 nanometers (nm) to approximately 560 nm. The light beam L2′ may include, for example but is not limited to green light. The optical module (not denoted in FIG. 1), which includes the lens 131 and the filter 141, provides or outputs a light beam L2′ of a wavelength range in accordance with light L2 reflected from the object 3. The light beam L2′ may be transmitted to the optical detector 15. The light beam L1 and the light beam L2 may be reflected by a same spot of the object 3. The light beam L1 and the light beam L2 may be reflected by different spots of the object 3, respectively.

An optical module (not denoted in FIG. 1) includes the lens 132 and the filter 142. The lens 132 is disposed in the aperture 122. The filter 142 is disposed in the aperture 122. The lens 132 is disposed between the filter 142 and the object 3. The optical module in the aperture 122 of the mask 12 directly provides light beams L3′ in accordance with light beam L3 reflected from the object to the optical detector 15. The optical module in the aperture 122 of the mask 12 directly provides light beams L4′ in accordance with light beam L4 reflected from the object to the optical detector 15.

The filter 142 is a band-pass filter. The filter 142 transmits light of the 430 nm to 470 nm wavelength region. The filter 142 transmits light of 470 nm to 510 nm wavelength region. The filter 142 transmits light of 510 nm to 550 nm wavelength region. The filter 142 transmits light of 550 nm to 590 nm wavelength region. The filter 142 transmits light of 590 nm to 630 nm wavelength region. The filter 142 transmits light of 630 nm to 670 nm wavelength region. The filter 142 transmits light of 670 nm to 710 nm wavelength region. The filter 142 transmits light of the 710 nm to 750 nm wavelength region wavelength region. It is contemplated that the filter 142 may transmit light of another wavelength region other than the above. The filter 142 transmits light of different wavelength region from the filter 141.

Light beam L3 is reflected by or from the object 3. Light beam L3 may pass through the lens 11 and reach the lens 132. Light beam L3 may be directed to the lens 132 by the lens 11. Light beam L3, which is incident on the lens 132, may be directed to the filter 142 by the lens 132. The filter 142, which receives the light beam L3, may provide or output a light beam L3′ of a wavelength range or spectrum, for example, from approximately 610 nm to approximately 630 nm. The light beam L3′ may include, for example but is not limited to red light. The optical module (not denoted in FIG. 1), which includes the lens 132 and the filter 142, provides or outputs a light beam L3′ of a wavelength range in accordance with light L3 reflected from the object 3. The light beam L3′ may be transmitted to the optical detector 15. The light beam L3′ has a wavelength different from that of the light beam L1′. The light beam L3′ has a wavelength different from that of the light beam L2′. The light beam L3′ has a wavelength in a wavelength range or spectrum from that of the light beam L1′. The light beam L3′ has a wavelength in a wavelength range or spectrum from that of the light beam L2′. The light beam L3′ and the light beam L1′ are full complementary. The light beam L3′ and the light beam L1′ are partially complementary. The light beam L3′ and the light beam L2′ are full complementary. The light beam L3′ and the light beam L2′ are partially complementary. The light beam L1 and the light beam L3 may be reflected by a same spot of the object 3. The light beam L1 and the light beam L3 may be reflected by different spots of the object 3, respectively. The light beam L2 and the light beam L3 may be reflected by a same spot of the object 3. The light beam L2 and the light beam L3 may be reflected by different spots of the object 3, respectively.

Light beam L4 is reflected by or from the object 3. Light beam L4 may pass through the lens 11 and reach the lens 132. Light beam L4 may be directed to the lens 132 by the lens 11. Light beam L4, which is incident on the lens 132, may be directed to the filter 142 by the lens 132. The filter 142, which receives the light beam L4, may provide or output a light beam L4′ of a wavelength range or spectrum, for example, from approximately 610 nm to approximately 630 nm. The light beam L4′ may include, for example but is not limited to red light. The optical module (not denoted in FIG. 1), which includes the lens 132 and the filter 142, provides or outputs a light beam L4′ of a wavelength range in accordance with light L4 reflected from the object 3. The light beam L4′ may be transmitted to the optical detector 15. The light beam L3 and the light beam L4 may be reflected by a same spot of the object 3. The light beam L3 and the light beam L4 may be reflected by different spots of the object 3, respectively. The light beam L1 and the light beam L4 may be reflected by a same spot of the object 3. The light beam L1 and the light beam L4 may be reflected by different spots of the object 3, respectively. The light beam L2 and the light beam L4 may be reflected by a same spot of the object 3. The light beam L2 and the light beam L4 may be reflected by different spots of the object 3, respectively. The light beam L4′ has a wavelength different from that of the light beam L1′. The light beam L4′ has a wavelength different from that of the light beam L2′. The light beam L4′ has a wavelength in a wavelength range or spectrum from that of the light beam L1′. The light beam L4′ has a wavelength in a wavelength range or spectrum from that of the light beam L2′. The light beam L4′ and the light beam L1′ are full complementary. The light beam L4′ and the light beam L1′ are partially complementary. The light beam L4′ and the light beam L2′ are full complementary. The light beam L4′ and the light beam L2′ are partially complementary.

The optical detector 15 may contain one or more photoelectric conversion elements, for example, a two-dimensional charge-coupled device (CCD) image sensor or a two-dimensional CMOS image sensor. The optical detector 15 may be a color image sensor which is capable of sensing or detecting light of a wide spectrum, for example but is not limited to, from 430 nm to 750 nm. The optical detector 15 detects light beams L1′, L2′, L3′ and L4′.

A method of collecting three dimensional information of an object 3 may include receiving the light beam L1′ or L2′ through the aperture 121 of the mask 12 in accordance with the light beam L1 or L2 reflected from the object 3 by the optical detector 15; and receiving the light beam L3′ or L4′) of through the aperture 122 of the mask 12 in accordance with the light beam L3 or L4) reflected from the object 3 by the optical detector 15. The method may further include receiving another light beam of a different wavelength range through another aperture of the mask 12 in accordance with the light reflected from the object 3, wherein the another aperture is separated from both the aperture 121 and the aperture 122 by the mask 12.

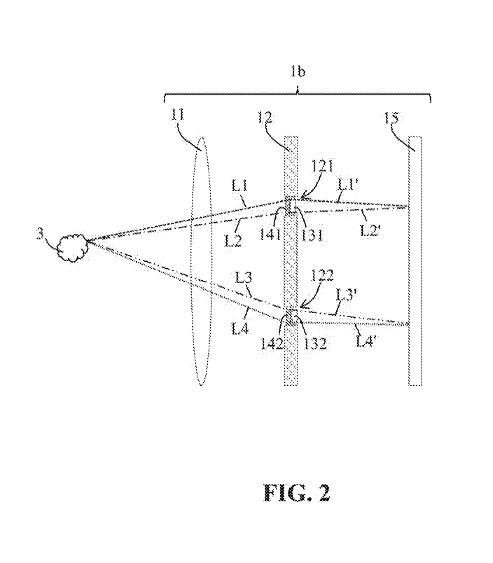

FIG. 2 illustrates an optical apparatus of collecting three dimensional information of an object in accordance with some embodiments of the present disclosure. Referring to FIG. 2, an optical apparatus 1b of collecting three dimensional information of an object 3 is similar to the optical apparatus 1a as described and illustrated with reference to FIG. 1, except that position of the lens 131 and position of the filter 141 are switched, and position of the lens 132 and position of the filter 142 are switched.

The filter 141 is disposed between the lens 131 and the object 3. Light beam L1 may pass through the lens 11 and reach the filter 141. The optical module in the aperture 121 of the mask 12 directly provides light beams L1′ in accordance with light beam L1 reflected from the object to the optical detector 15. The optical module in the aperture 121 of the mask 12 directly provides light beams L2′ in accordance with light beam L2 reflected from the object to the optical detector 15. Light beam L1 may be directed to the filter 141 by the lens 11. The filter 141, which receives the light beam L1, may provide or output a light beam L1′ of a wavelength range or spectrum, for example, from approximately 540 nanometers (nm) to approximately 560 nm. The light beam L1′ may include, for example but is not limited to green light. The optical module (not denoted in FIG. 2), which includes the lens 131 and the filter 141, provides or outputs a light beam L1′ of a wavelength range in accordance with light L1 reflected from the object 3. The light beam L1′ may be transmitted or directed to the optical detector 15 by the lens 131.

Light beam L2 is reflected by or from the object 3. Light beam L2 may pass through the lens 11 and reach the filter 141. Light beam L2 may be directed to the filter 141 by the lens 11. The filter 141, which receives the light beam L2, may provide or output a light beam L2′ of a wavelength range or spectrum, for example, from approximately 540 nanometers (nm) to approximately 560 nm. The light beam L2′ may include, for example but is not limited to green light. The optical module (not denoted in FIG. 2), which includes the lens 131 and the filter 141, provides or outputs a light beam L2′ of a wavelength range in accordance with light L2 reflected from the object 3. The light beam L2′ may be transmitted or directed to the optical detector 15 by the lens 131.

The filter 142 is disposed between the lens 132 and the object 3. The optical module in the aperture 122 of the mask 12 directly provides light beams L3′ in accordance with light beam L3 reflected from the object to the optical detector 15. The optical module in the aperture 122 of the mask 12 directly provides light beams L4′ in accordance with light beam L4 reflected from the object to the optical detector 15.

Light beam L3 may pass through the lens 11 and reach the filter 142. Light beam L3 may be directed to the filter 142 by the lens 11. The filter 142, which receives the light beam L3, may provide or output a light beam L3′ of a wavelength range or spectrum, for example, from approximately 610 nm to approximately 630 nm. The light beam L3′ may include, for example but is not limited to red light. The optical module (not denoted in FIG. 2), which includes the lens 132 and the filter 142, provides or outputs a light beam L3′ of a wavelength range in accordance with light L3 reflected from the object 3. The light beam L3′ may be transmitted or directed to the optical detector 15 by the lens 131.

Light beam L4 may pass through the lens 11 and reach the lens 132. Light beam L4 may be directed to the filter 142 by the lens 11. The filter 142, which receives the light beam L4, may provide or output a light beam L4′ of a wavelength range or spectrum, for example, from approximately 610 nm to approximately 630 nm. The light beam L4′ may include, for example but is not limited to red light. The optical module (not denoted in FIG. 2), which includes the lens 132 and the filter 142, provides or outputs a light beam L4′ of a wavelength range in accordance with light L4 reflected from the object 3. The light beam L4′ may be transmitted or directed to the optical detector 15 by the lens 132.

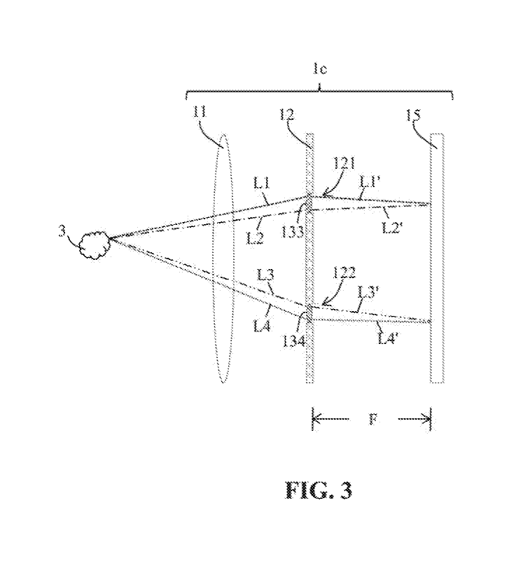

FIG. 3 illustrates an optical apparatus of collecting three dimensional information of an object in accordance with some embodiments of the present disclosure. Referring to FIG. 3, an optical apparatus 1c of collecting three dimensional information of an object 3 is similar to the optical apparatus 1a as described and illustrated with reference to FIG. 1 or to the optical apparatus 1b as described and illustrated with reference to FIG. 2, except that the lens 131 and the filter 141 are replaced by an optical module 133, and the lens 132 and the filter 142 are replaced by an optical module 134.

The optical module 133 may include a lens similar to lens 131. The optical module 133 may include an optical film on the lens. The optical film formed on a surface of the lens of the optical module 133 may be a band-pass filter film that may function as the filter 141.

The optical module 134 may include a lens similar to 132. The optical module 134 may include an optical film on the lens. The optical film formed on a surface of the lens of the optical module 134 may be a band-pass filter film that may function as the filter 142. A distance F is determined from the mask 12 to the optical detector 15.

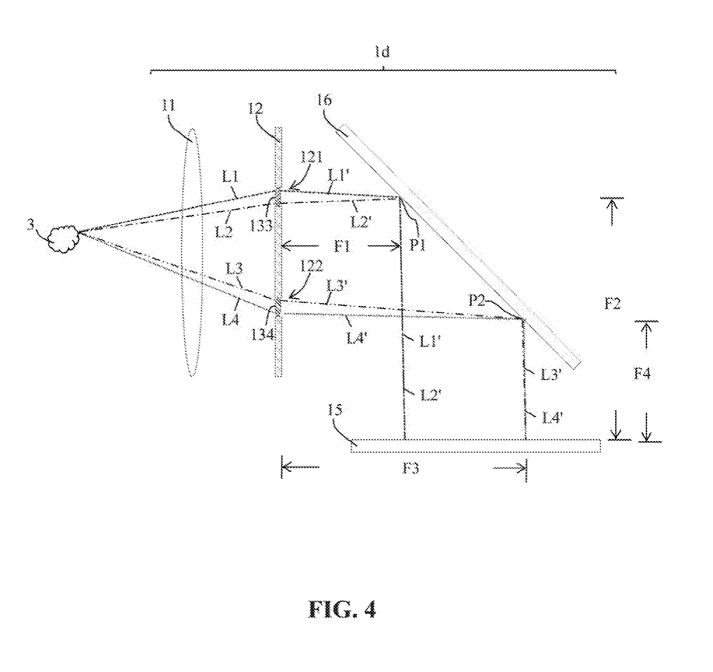

FIG. 4 illustrates an optical apparatus of collecting three dimensional information of an object in accordance with some embodiments of the present disclosure. Referring to FIG. 4, an optical apparatus 1d of collecting three dimensional information of an object 3 is similar to the optical apparatus 1c as described and illustrated with reference to FIG. 3, except that the optical apparatus 1d further includes a mirror 16.

The optical module 133 in the aperture 121 of the mask 12 provides light beams L1′ in accordance with light beam L1 reflected from the object to the mirror 16. Light beam L1 may be directed to the optical module 133 by the lens 11. The optical module 133, which receives the light beam L1, may provide or output a light beam L1′ of a wavelength range or spectrum, for example, from approximately 540 nanometers (nm) to approximately 560 nm. The light beam L1′ may include, for example but is not limited to green light. The optical module 133 provides or outputs a light beam L1′ of a wavelength range in accordance with light L1 reflected from the object 3. The light beam L1′ may be transmitted or directed to the mirror 16 by the optical module 133. The mirror 16 directs the light beam L1′ to the optical detector 15. The light beam L1′ incident on the mirror 16 may be directed or redirected to the optical detector 15 by the mirror 16.

The optical module 133 in the aperture 121 of the mask 12 provides light beams L2′ in accordance with light beam L2 reflected from the object to the mirror 16. Light beam L2 may be directed to the optical module 133 by the lens 11. The optical module 133, which receives the light beam L2, may provide or output a light beam L2′ of a wavelength range or spectrum, for example, from approximately 540 nanometers (nm) to approximately 560 nm. The light beam L2′ may include, for example but is not limited to green light. The optical module 133 provides or outputs a light beam L2′ of a wavelength range in accordance with light L2 reflected from the object 3. The light beam L2′ may be transmitted or directed to the mirror 16 by the optical module 133. The mirror 16 directs the light beam L2′ to the optical detector 15. The light beam L2′ incident on the mirror 16 may be directed or redirected to the optical detector 15 by the mirror 16.

The optical module 134 in the aperture 122 of the mask 12 provides light beams L3′ in accordance with light beam L3 reflected from the object to the the mirror 16. Light beam L3 may be directed to the optical module 134 by the lens 11. The optical module 134, which receives the light beam L3, may provide or output a light beam L3′ of a wavelength range or spectrum, for example, from approximately 610 nm to approximately 630 nm. The light beam L3′ may include, for example but is not limited to red light. The optical module 134 provides or outputs a light beam L3′ of a wavelength range in accordance with light L3 reflected from the object 3. The light beam L3′ may be transmitted or directed to the mirror 16 by the optical module 134. The mirror 16 directs the light beam L3′ to the optical detector 15. The light beam L3′ incident on the mirror 16 may be directed or redirected to the optical detector 15 by the mirror 16.

The optical module 134 in the aperture 122 of the mask 12 directly provides light beams L4′ in accordance with light beam L4 reflected from the object to the optical detector 15. Light beam L4 may be directed to the optical module 134 by the lens 11. The optical module 134, which receives the light beam L4, may provide or output a light beam L4′ of a wavelength range or spectrum, for example, from approximately 610 nm to approximately 630 nm. The light beam L4′ may include, for example but is not limited to red light. The optical module 134 provides or outputs a light beam L4′ of a wavelength range in accordance with light L4 reflected from the object 3. The light beam L4′ may be transmitted or directed to the mirror 16 by the optical module 134. The mirror 16 directs the light beam L4′ to the optical detector 15. The light beam L4′ incident on the mirror 16 may be directed or redirected to the optical detector 15 by the mirror 16.

The mask 12, optical detector 15 and the mirror 16 may be arranged as shown in FIG. 4. A distance F1 is determined from the mask 12 to a point P1 of the mirror 16 on which the light beam L1′ is incident. A distance F1 is determined from the mask 12 to a point P1 of the mirror 16 on which the light beam L2′ is incident. A distance F2 is determined from a point P1 of the mirror 16 on which the light beam L1′ is incident to the optical detector 15. A distance F2 is determined from a point P1 of the mirror 16 on which the light beam L2′ is incident to the optical detector 15. A distance F3 is determined from the mask 12 to a point P2 of the mirror 16 on which the light beam L3′ is incident. A distance F3 is determined from the mask 12 to a point P2 of the mirror 16 on which the light beam L4′ is incident. A distance F4 is determined from a point P2 of the mirror 16 on which the light beam L3′ is incident to the optical detector 15. A distance F4 is determined from a point P2 of the mirror 16 on which the light beam L4′ is incident to the optical detector 15. A sum of the distance F1 and the distance F2 is substantially the same to the distance F as shown in FIG. 3. A sum of the distance F3 and the distance F4 is substantially the same to the distance F as shown in FIG. 3.

It is contemplated that geometric relation between the object 3, mask 12, apertures, 121 and 122, lenses 11, 131 and 132, filters 141 and 142, optical detector 15 and the mirror 16 as described and illustrated with reference to each of FIGS. 1, 2, 3 and 4 may be varied.

It is contemplated that the optical apparatuses 1a, 1b, 1c and 1d may further include electronics (not shown in FIGS. 1, 2, 3 and 4). The electronics of the optical apparatus 1a, 1b, 1c and 1d may include a memory, a processor, a controller, etc. For example, optical information (e.g. the light beams L1′, L2′, L3′ and L4′) received by the optical detector 15 may be stored in the electronics (e.g. the memory). For example, the controller may control the detector 15 (e.g. to move or rotate the detector 15 to adjust the field of view of each of the optical apparatus 1a, 1b, 1c and 1d).

Although it is not illustrated, the mask 12 may include one or more apertures other than apertures 121 and 122. The mask 12 may include another optical module(s) (not shown) similar to the optical modules as described above in the aperture(s) separated from apertures 121 and 122 by the mask 12. The mask 12 may include another optical module(s) which may provide a light beam of a wavelength range or spectrum different from that provided by the optical module 133 or 134.

It is contemplated that the optical module as described and illustrated with reference to any of FIGS. 1, 2, 3 and 4 may be switched by another module to provide a light beam of different wavelength range or spectrum.

It is contemplated that the optical apparatuses 1a, 1b, 1c and 1d may further include an illumination source 16 (not shown in FIGS. 1, 2, 3 and 4). The illumination source may be disposed relatively close to the object 3. The illumination source may illuminate a light pattern, for example but is not limited to randomly distributed light spots, a star, a triangle, etc. The illumination source may illuminate a light beam of a wavelength range or spectrum overlapping both the wavelength range or spectrum of the light beam L1′ and the wavelength range or spectrum of the light beam L3′. The illumination source may illuminate a light beam of a wavelength range or spectrum overlapping both the wavelength range or spectrum of the light beam L1′ and the wavelength range or spectrum of the light beam L4′. The illumination source may illuminate a light beam of a wavelength range or spectrum overlapping both the wavelength range or spectrum of the light beam L2′ and the wavelength range or spectrum of the light beam L3′. The illumination source may illuminate a light beam of a wavelength range or spectrum overlapping both the wavelength range or spectrum of the light beam L2′ and the wavelength range or spectrum of the light beam L4′.

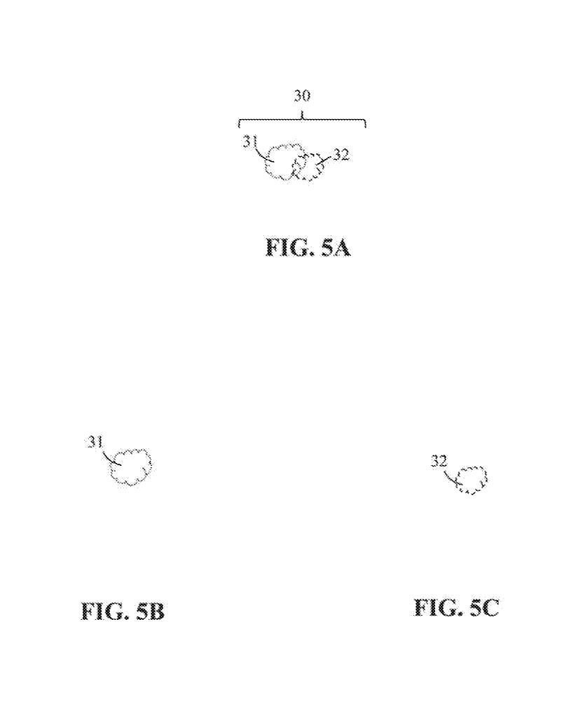

FIG. 5A illustrates an image 30 of an object 3 in accordance with some embodiments of the present disclosure. Optical information of the light beams L1′, L2′, L3′ and L4′ may be collected or received by the optical detector 15 from a single shot and stored to the electronics (e.g. memory). Geometric information (e.g. position) of components (e.g. one of more of the object 3, mask 12, apertures, 121 and 122, lenses 11, 131 and 132, filters 141 and 142, and optical detector 15 etc.) may be stored in the memory. The electronics (e.g. a processor) or an external computing device electrically connected to the optical apparatuses as described above may determine the image 30 in accordance with the optical and geometric information. The image 30 may be decomposed to images 31 and 32 in accordance with optical information received by the optical detector 15. Disparity between images 31 and 32 may be used to determine a three dimensional data of the object 3 by, for example but is not limited to triangulation technique.

FIG. 5B illustrates an image of an object in accordance with some embodiments of the present disclosure. Referring to FIG. 5A, an image 31 of the object 3 may include information associated with the light beams L1′ and L2′. The image 31 of the object 3 may include information associated with position of one of more of the object 3, mask 12, apertures, 121 and 122, lenses 11, 131 and 132, filters 141 and 142, and optical detector 15. The image 31 of the object 3 may include optical information associated with the light beams L1′ and L2′. Light reflected from the object 3 which passes the aperture 121, may include, for example but is not limited to light beams L1 and L2, are be filtered and transmitted to the optical detector 15 to form the image 31.

FIG. 5C illustrates an image of an object in accordance with some embodiments of the present disclosure. Referring to FIG. 5C, an image 32 of the object 3 may include information associated with the light beams L3′ and L4′. The image 32 of the object 3 may include information associated with position of one of more of the object 3, mask 12, apertures, 121 and 122, lenses 11, 131 and 132, filters 141 and 142, and optical detector 15. The image 32 of the object 3 may include optical information associated with the light beams L3′ and L4′. Light reflected from the object 3 which passes the aperture 122, may include, for example but is not limited to light beams L3 and L4, are be filtered and transmitted to the optical detector 15 to form the image 32.

In accordance with some embodiments of the present disclosure, an optical apparatus of collecting three dimensional information of an object includes an optical detector, a mask, a first optical module and a second optical module. The mask has a first aperture and a second aperture separated from the first aperture by the mask. The first optical module in the first aperture to provide a first light beam of a first wavelength range in accordance with light reflected from the object. The second optical module in the second aperture to provide a second light beam of a second wavelength range in accordance with the light reflected from the object.

In accordance with some embodiments of the present disclosure, a method of collecting three dimensional information of an object includes: receiving a first light beam of a first wavelength range through a first aperture of a mask in accordance with light reflected from the object; and receiving a second light beam of a second wavelength range through a second aperture of the mask in accordance with the light reflected from the object, wherein the second aperture is separated from the first aperture by the mask.

In accordance with some embodiments of the present disclosure, an optical apparatus of collecting three dimensional information of an object includes an optical detector and a mask. The optical detector detects a first light beam of a first wavelength range and a second light beam of a second wavelength range different from the first wavelength range. The mask includes a first optical module and a second optical module. The first optical module directly provides the first light beam in accordance with light reflected from the object to the optical detector. The second optical module directly provides the second light beam in accordance with light reflected from the object to the optical detector.

The foregoing outlines features of several embodiments so that those skilled in the art may better understand the aspects of the present disclosure. Those skilled in the art should appreciate that they may readily use the present disclosure as a basis for designing or modifying other processes and structures for carrying out the same purposes and/or achieving the same advantages of the embodiments introduced herein. Those skilled in the art should also realize that such equivalent constructions do not depart from the spirit and scope of the present disclosure, and that they may make various changes, substitutions, and alterations herein without departing from the spirit and scope of the present disclosure.

What is claimed is:

1. An optical apparatus of collecting three dimensional information of an object, comprising:
an optical detector; and
a mask having a first aperture and a second aperture separated from the first aperture by the mask;
a first optical module in the first aperture and providing a first light beam of a first wavelength range in accordance with light reflected from the object; and
a second optical module in the second aperture and providing a second light beam of a second wavelength range in accordance with the light reflected from the object.

2. The optical apparatus of claim 1, wherein the first optical module comprises:
a first filter; and
a first lens between the object and the first filter,
wherein the first filter receives the light reflected from the object through the first lens and outputs the first light beam to the optical detector.

3. The optical apparatus of claim 1, wherein the first optical module comprises:
a first lens; and
a first filter between the object and the first lens,
wherein the first filter receives the light reflected from the object and outputs the first light beam, wherein the first lens directs the first light beam to the optical detector.

4. The optical apparatus of claim 1, wherein the first optical module comprises a lens having an optical film thereon, wherein the optical film receives the light reflected from the object and outputs the first light beam, wherein the lens directs the first light beam to the optical detector.

5. The optical apparatus of claim 1, further comprising a lens between the object and the mask.

6. The optical apparatus of claim 1, further comprising a mirror to direct the first light beam to the optical detector.

7. The optical apparatus of claim 1, wherein the mask further comprises a third aperture separated from the first aperture and the second aperture by the mask and a third optical module in the third aperture, the third optical module provides a third light beam of a third wavelength range in accordance with light reflected from the object.

8. The optical apparatus of claim 7, wherein the first optical module and the third optical module are switchable.

9. The optical apparatus of claim 1, further comprising an illumination source illuminating a light pattern of the first wavelength range and the second wavelength range.

10. A method of collecting three dimensional information of an object, comprising:
receiving a first light beam of a first wavelength range through a first aperture of a mask in accordance with light reflected from the object; and
receiving a second light beam of a second wavelength range through a second aperture of the mask in accordance with the light reflected from the object,
wherein the second aperture is separated from the first aperture by the mask.

11. The method of claim 10, further comprising receiving a third light beam of a third wavelength range through a third aperture of the mask in accordance with the light reflected from the object, wherein the third aperture is separated from both the first aperture and the second aperture by the mask.

12. An optical apparatus of collecting three dimensional information of an object, comprising:
an optical detector detecting a first light beam of a first wavelength range and a second light beam of a second wavelength range different from the first wavelength range; and
a mask comprising:
a first optical module directly providing the first light beam in accordance with light reflected from the object to the optical detector; and
a second optical module directly providing the second light beam in accordance with light reflected from the object to the optical detector.

13. The optical apparatus of claim 12, wherein the mask further comprises a first aperture and a second aperture separated from the first aperture by the mask.

14. The optical apparatus of claim 13, wherein the first optical module is disposed in the first aperture and the second optical module is disposed in the second aperture.

15. The optical apparatus of claim 12, wherein the first optical module comprises:
a first filter; and
a first lens between the object and the first filter,
wherein the first filter receives the light reflected from the object through the first lens and outputs the first light beam to the optical detector.

16. The optical apparatus of claim 12, wherein the first optical module comprises:
a first lens; and
a first filter between the object and the first lens,
wherein the first filter receives the light reflected from the object and outputs the first light beam, wherein the first lens directs the first light beam to the optical detector.

17. The optical apparatus of claim 12, wherein the first optical module comprises a lens having an optical film thereon, wherein the optical film receives the light reflected from the object and outputs the first light beam, wherein the lens directs the first light beam to the optical detector.

18. The optical apparatus of claim 12, further comprising a lens between the object and the mask.

19. The optical apparatus of claim 12, wherein the mask further comprises a third aperture separated from the first aperture and the second aperture by the mask and a third optical module in the third aperture, the third optical module directly provides a third light beam of a third wavelength range in accordance with light reflected from the object.

20. The optical apparatus of claim 19, wherein the first optical module and the third optical module are switchable.
